(19) United States
(12) Patent Application Publication
(10) Pub. No.: US 2025/0169529 A1
(43) Pub. Date: May 29, 2025

(54) A FOOD PROCESSING MACHINE AND METHODS OF OPERATION THEREOF

(71) Applicant: THURNE-MIDDLEBY LTD, Norwich Norfolk (GB)

(72) Inventors: James WAKEFIELD, Norwich Norfolk (GB); Alastair FEARNS, Norwich Norfolk (GB); Adrian NEAVE, Norwich Norfolk (GB); Adam GRANGER, Norwich Norfolk (GB)

(21) Appl. No.: 18/842,747

(22) PCT Filed: Apr. 12, 2023
(86) PCT No.: PCT/GB2023/050977

§ 371 Date: Aug. 29, 2024

(30) Foreign Application Priority Data
Apr. 13, 2022 (GB) 2205486.0

(51) Int. Cl. A23P 30/10; B26D 7/27

(52) U.S. Cl. CPC A23P 30/10; B26D 7/27; B26D 2210/04

(57) ABSTRACT

A food processing machine (2) wherein a food product is continuously constrained against movement laterally with respect to a product flow path (D) by a transport system as the food product travels from a forming module (8) to a cutter (18) via a sensing region (10). A forming module (8) comprises at least three dies (100, 102, 104, 106), with each die defining an inwardly facing shaping surface, wherein each die has a longitudinally extending side which moves over the shaping surface of an adjacent die when the dies move between larger and smaller transverse product profile configurations. A size-adaptive end pusher (120) for use in a forming module (8), the end pusher comprising two pusher elements (160, 162, 164, 166), wherein the pusher elements are movable between a transversely expanded configuration and a transversely contracted configuration.

### FIELD OF THE DISCLOSURE

The present disclosure relates to a food processing machine and a method for operating such a machine to cut slices or portions from a food product. More particularly, it concerns control of the slice or portion weight and minimising wastage.

### BACKGROUND TO THE DISCLOSURE

It is known to feed food products such as bacon, cheese, fresh meat or cooked meat towards a cutting region in a food processing machine using product drivers such as belt conveyors, tracks or rear end grippers. The food product, which may be in the form of an elongate loaf, log or block for example, is fed incrementally towards the cutting region, where slices or portions of a desired size are cut from a leading end of the food product.

In order to optimise their rate of throughput and to minimise the extent to which portions deviate from the desired weight, it is desirable for such machines to operate at high speed, whilst at the same time providing close control of the weight of the slices or portions outputted by the machine.

In addition, it is cost effective to optimise the amount of an incoming food product that is used to form slices or portions that meet weight and quality requirements. These slices or portions can then be grouped together and sold to a consumer. This minimises the amount of the food product, if any, that remains and therefore may only be used for other, less valuable purposes.

### SUMMARY OF THE DISCLOSURE

The present disclosure provides a food processing machine comprising:
a cutter configured to cut portions from a food product;
a forming module for changing the shape of a food product;
a transport system arranged to carry a food product along a product flow path from the forming module to the cutter; and
a profile sensor configured to sense a profile of part of a food product as a food product is carried from the forming module to the cutter through a sensing region of the machine by the transport system,
wherein a food product is continuously constrained against movement laterally with respect to the product flow path by the transport system as the food product travels from the forming module to the cutter via the sensing region.

By providing a profile sensor in the same machine as both the cutter and the forming module, it is possible to provide continuous constraint of the food product all of the way from the forming module, through the sensing region, and from the sensing region to the cutter. This facilitates more precise control of the size of the slices or portions cut from the food product by the cutter, as the location of the food product as it is cut is reliably controlled.

In existing processing lines, product scanning is carried out in a machine separate to that used for cutting the food product. In such an arrangement, there is a risk that the product may shift laterally or rotate, or be deformed, between scanning and cutting, thereby reducing the accuracy of the cutting process.

In examples of the present food processing machine, a food product may be restrained against movement relative to the surface(s) of the transport system which is in contact with the food product. In this way, the lateral position and/or the orientation of the food product within the machine may be continuously controlled whilst it is carried by the transport system from the forming module, through the sensing region and to the cutter.

A food product may be laterally constrained by engaging a pair of side guides with respective side regions of the product as it is carried by the transport system. Alternatively, or in addition, a top guide may be used to exert a downward force on an upper region of a food product as it is carried by the transport system. The side and/or top guides may provide static or moving contact surfaces for engagement with a food product. Moving contact surfaces may be provided by driven belts or toothed tracks, for example.

Preferably, the constraint by the transport system starts to be applied to a food product before its trailing end has left the forming module.

The constraint applied by the transport system may act to minimise any deformation or relaxation of a food product as it travels from the forming module to the cutter. The food product will therefore be more likely to retain a desired outer profile imposed on the food product by the forming module all the way through to the cutting region.

The profile sensor may be one of a plurality of profile sensors provided to sense the profile of different or overlapping circumferential regions of the product as it passes the sensors.

In preferred examples, the forming module is operable to cool the surface of a food product. This tends to enhance the ability of a food product to retain a desired outer profile imposed on the food product by the forming module, as it travels through the machine. In particular, the forming module may be able to extract sufficient heat energy from the surface of a food product to freeze at least an outer layer of the food product. This serves to increase the rigidity of the food product as a whole, further improving the retention of a desired profile by the food product as it travels through the machine.

The forming module may include a die for engaging a food product in order to change the shape of the food product, with the forming module being operable to extract heat energy from the die. Accordingly, a surface of the die may define a shape to be imposed on part of a food product and cooling of the die may enhance the retention of this shape by the food product. The die may include an inlet and outlet for a coolant fluid and define a fluid path extending therebetween to enable the die to be cooled using a flow of a suitable fluid along the fluid path.

The product flow path may follow a straight line all the way from the forming module to the cutter.

The product flow path from the forming module to the cutter may be inclined relative to horizontal. As a result, slices or portions cut from a leading end of a food product will naturally tend to fall away from the cutter in a reliable and predictable manner, facilitating accurate handling of each slice or portion. The constraint applied by the transport system may resist any tendency of the food product to shift owing to the inclination of the flow path.

The forming module preferably includes a support structure, and a base for supporting a food product, wherein the base is carried by the support structure, and the base is moveable relative to the support structure in a lateral direction to adjust laterally the location of a food product relative to the product flow path. The forming module is thereby able to adjust laterally the food product location relative to a base or supporting structure of the processing machine so that it is aligned with a centre line of the flow path before it moves from the forming module along the flow path.

The present disclosure also provides a forming module for changing the shape of a food product located in the module, wherein:
the module comprises at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations.

The transverse product profile may extend around a part or the entire circumference of a food product in a transverse plane. The dies may be arranged to extend around an upper surface only of a food product, with an open side of the module being closed in use by a support surface below the food product, such as a conveyor belt for example.

The forming module may be installed in a food processing machine with the transverse product profile arranged to be transverse with respect to the flow path of food products through the machine.

The longitudinally extending side of each die may be arranged to be closely adjacent to or in contact with the shaping surface of an adjacent die which it is able to move over.

In some implementations, the module includes four dies. The four dies may be arranged to extend around a part or the entire circumference of a food product in a transverse plane.

One of the dies may be a front side die which defines a side portion of the transverse product profile, and the front side die may be retractable so as to enable insertion of a food product into the module in a transverse direction. The front side die may be retractable along a path having a component in the vertical direction, for example.

The module may include a first drive for moving an upper die towards and away from a lower die in a transverse direction, and a second drive for moving a rear side die towards and away from a or the front side die in a transverse direction.

An upper die force sensor may be provided for generating a signal indicative of the magnitude of a force opposing movement of the upper die towards the lower die in a transverse direction. A rear side die force sensor may be provided for generating a signal indicative of the magnitude of a force opposing movement of the rear side die towards the front side die in a transverse direction.

The module may include a third drive for moving the front side die and lower die towards and away from the rear side die in a transverse direction. A further die force sensor may be provided for generating a signal indicative of the magnitude of a force opposing movement of the front side and lower dies towards the rear side die.

A signal from a force sensor may be used by a controller for an associated drive to govern the force exerted by the die on the food product during a forming process.

The present disclosure further provides a size-adaptive end pusher for use in a food product forming module, the end pusher being driven in use to exert a pushing force on a food product in a direction along a longitudinal axis of the end pusher and comprising:
two pusher elements, each defining a transversely extending front face for engaging with a food product,
wherein the pusher elements are movable between a transversely expanded configuration and a transversely contracted configuration, with the front faces overlapping when viewed in the longitudinal direction to a greater extent in the expanded configuration relative to the contracted configuration, and the pusher elements are resiliently biased away from the transversely contracted configuration towards the transversely expanded configuration.

An end pusher of this form is suitable for insertion into a product forming module, where it is able to contract in a transverse plane as the forming module acts on a food product during a forming process. Thus, the end pusher may be able to conform closely to an inner profile defined by the product forming module. This minimises the risk of a peripheral region of the food product “escaping” between the end pusher and the forming module, leading to undesirable deformation of an end portion of the food product.

The end pusher may include at least four pusher elements, for example. The use of a greater number of pusher elements may enable the end pusher to more closely conform to an inner profile defined by a product forming module.

In preferred examples, the end pusher includes a pusher mount, and a resilient support between the pusher mount and a respective pusher element, wherein each resilient support urges the respective pusher element away from its position in the contracted configuration towards its position in the expanded configuration. The resilient supports may therefore act to resiliently bias the respective pusher elements.

For example, each resilient support may comprise a resilient rod having one end coupled to the pusher mount and the other end coupled to the respective pusher element. Each other end of each resilient support may be coupled to the respective pusher element by a coupling which allows the pusher element to pivot about the other end.

Each pusher element may define a longitudinally extending outer side face which is perpendicular to its front face, for engaging with an inner wall of a food product forming module. This outer side face may align with the wall and thereby cause the front face to be maintained in a transverse orientation, leading to flattening of an end face of a food product in a transverse plane. As a result, an end portion of the food product may be used to form a portion meeting preferred size and weight requirements.

When the pusher elements are in their contracted configuration, the front face of only one pusher element may be visible when the front faces are viewed in the longitudinal direction.

A forming module as described herein may include an end pusher according to the present disclosure.

In addition, the present disclosure provides a method of processing a food product with a food processing machine, the method comprising the steps of:
changing the shape of the food product in a forming module of the machine;
transporting the food product along a product flow path from the forming module to a cutter of the machine using a transport system of the machine; and
sensing a profile of part of the food product as it is transported from the forming module to the cutter,
wherein food product is continuously constrained against movement laterally with respect to the product flow path by the transport system as the food product travels from the forming module to the cutter via the sensing region.

In some preferred examples, the forming module includes a base for supporting a food product, and the method includes a step of adjusting laterally the location of the base within the machine relative to the product flow path through the machine to laterally adjust the location of a food product carried by the base relative to the product flow path. In this way, the forming module may align with the product flow path through downstream modules of the machine.

The present disclosure also provides a method for changing the shape of a food product located in a food product forming module, wherein:
the module comprises a support structure and at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations,
the method comprising the steps of:
inserting a food product into the forming module, and
moving the dies from the large transverse product profile configuration to the small transverse product profile configuration to change the shape of the food product.

The method may include cooling the food product using the dies. The method may include a step of extracting heat energy from the dies to cool the surface of the food product. The dies may extract heat energy from the food product during and/or after the die moving step.

One of the dies may be a lower die for supporting a food product, wherein the method includes moving the lower die relative to the support structure in a transverse direction to adjust laterally the location of a food product relative to a product flow path.

### BRIEF DESCRIPTION OF THE DRAWINGS

Examples of the present disclosure will now be described with reference to the accompanying schematic drawings, wherein:

FIG. 1 is a side view of a food processing machine according to an example of the present disclosure;

FIG. 2 is a front view of a product control assembly of the machine of FIG. 1;

FIGS. 3 and 4 are front views of selected components of the product control assembly of FIG. 2 to illustrate operation thereof;

FIG. 5 is a perspective view of a product control assembly, cutter and conveyor of the machine shown in FIG. 1;

FIG. 6 is a perspective view of a forming module of the machine shown in FIG. 1;

FIGS. 7 to 10 are end views of successive stages in operation of the forming module of FIG. 6;

FIGS. 11 and 12 are perspective views of a die of the forming module shown in FIGS. 6 to 10; and

FIGS. 13 and 14 are perspective views of an end pusher in contracted and expanded configurations, respectively.

### DETAILED DESCRIPTION

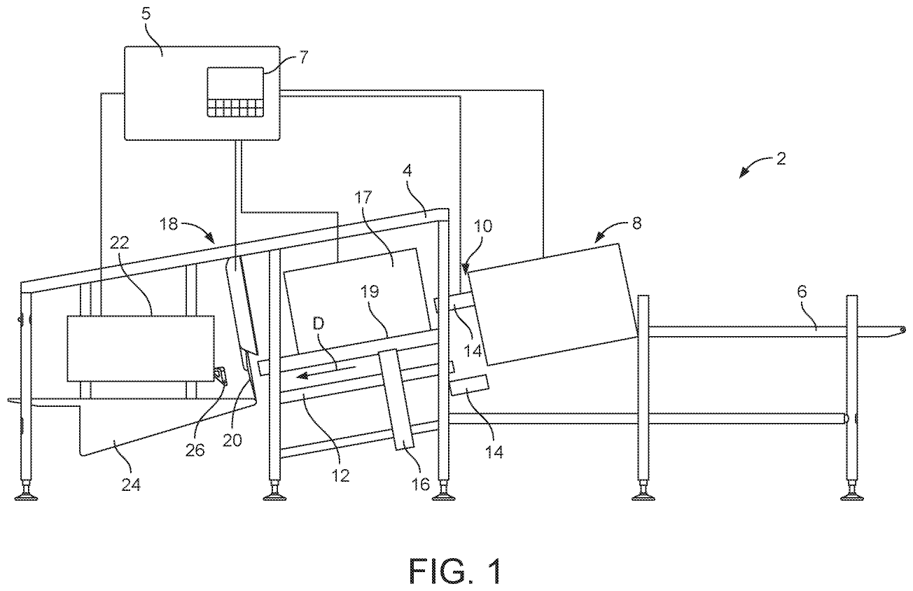

FIG. 1 shows a food portioning machine 2 having a machine base in the form of a rigid base framework 4. The operation of the machine is governed by an electronic control system 5 which is communicatively coupled to components of the machine. The control system includes a user interface 7 to enable an operator to input control parameters and commands.

Food products to be processed by the machine are loaded consecutively onto a horizontal pre-feed conveyor 6. The food products are then passed by the pre-feed conveyor to a forming module 8. The path of the food products through the forming module 8 is inclined downwardly in a direction away from the pre-feed conveyor.

The forming module 8 is arranged to change the shape of a food product, as will be described in more detail below.

The food products then move from the forming module 8 onto a feed conveyor 12. A scanning region 10 is located between the forming module 8 and the feed conveyor 12. The scanning region includes two or more scanning devices 14 which are configured to detect the transverse cross-sectional shape of the food product as it passes through the region. For example, each scanning device may include a light source for projecting a line of light across the product which is detectable by a camera of the scanning device.

An end gripper 16 may be provided for engaging a trailing end of a food product carried by the feed conveyor 12. The end gripper and feed conveyor cooperate to form a feeder for feeding each food product in a feed direction “D” towards a cutter 18. As the food product travels from the forming module towards the cutter, it is engaged by a product control assembly 17. The food product is constrained laterally by a pair of side guides 19 of the product control assembly, which exert forces on respective sides of the food product. A product control assembly of this form is described in a co-pending UK patent application filed by the present applicant, and discussed further below.

The cutter includes a blade 20. The blade 20 may be in the form of an orbitally-mounted circular blade, an involute blade or a sickle-shaped knife blade, for example.

A portion thickness control assembly 22 is provided downstream of the cutter 18. It includes a product stop 26 which is operable to control the thickness of the slices or portions cut from a food product. The product stop is able to reciprocate between advanced and retracted positions. In operation of the machine, the advanced position of the product stop determines the extent to which the food product extends beyond the cutting plane and therefore the thickness of the next slice or portion to be cut from the food product. After cutting of the next slice or portion has started, the product stop is moved to its retracted position to allow the slice or portion to fall freely away from the end of the food product. A portion thickness control assembly of this form is described in a co-pending UK patent application filed by the present applicant.

A jump conveyor and stacker assembly 24 is located below the portion thickness control assembly. Slices or portions cut from a food product by the cutter fall onto the assembly 24 which is operable to arrange consecutive slices or portions in a desired configuration, such as groups, or vertical or shingled stacks, for example. The assembly 24 conveys the slices or portions towards a packaging station (not shown).

An elongate food product log is constrained laterally by the forming module as it is moved out of the module by maintaining shaping surfaces of the module in contact with the food product, and its leading end will be contacted and constrained laterally by the side guides before its trailing end has left the lateral constraint of the forming module. The side guides then continue to constrain the food product laterally as it moves towards and past the blade 20.

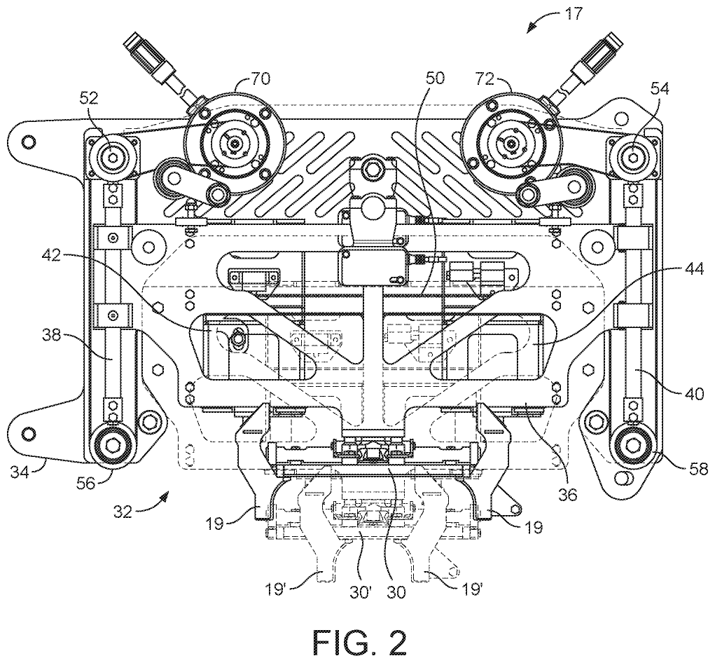

A suitable product control assembly 17 will now be described by way of example with reference to FIGS. 2 to 5.

It will be appreciated that other movement generating structures may be used to move the side guides (and also optionally a top guide) relative to the assembly support and to change the spacing between the side guides. Such structures may for example use linear actuators, ball screws, pistons, drive belts, pulleys, and/or dedicated motors for moving the side guides towards and away from the support plane and moving the side guides towards and away from each other, respectively. One of ordinary skill in the art would readily comprehend how to construct suitable structures with the desired functionality having regard to the present specification without undue experimentation.

The product control assembly 17 assembly includes a top guide 30 and a pair of side guides 19. The top and side guides are carried by a positioning mechanism 32 which is carried by an assembly support in the form of a supporting framework 34. In a food portioning machine, the supporting framework 34 is rigidly mounted onto a support or a housing which forms part of the food portioning machine.

The positioning mechanism includes a main body 36 which is coupled to the supporting framework in such a way that it is able to move linearly relative to the supporting framework. In the example of FIG. 2, the main body is slidably coupled to a pair of elongate parallel guide members 38, 40 which form part of the supporting framework. The top guide 30 is rigidly coupled to the main body.

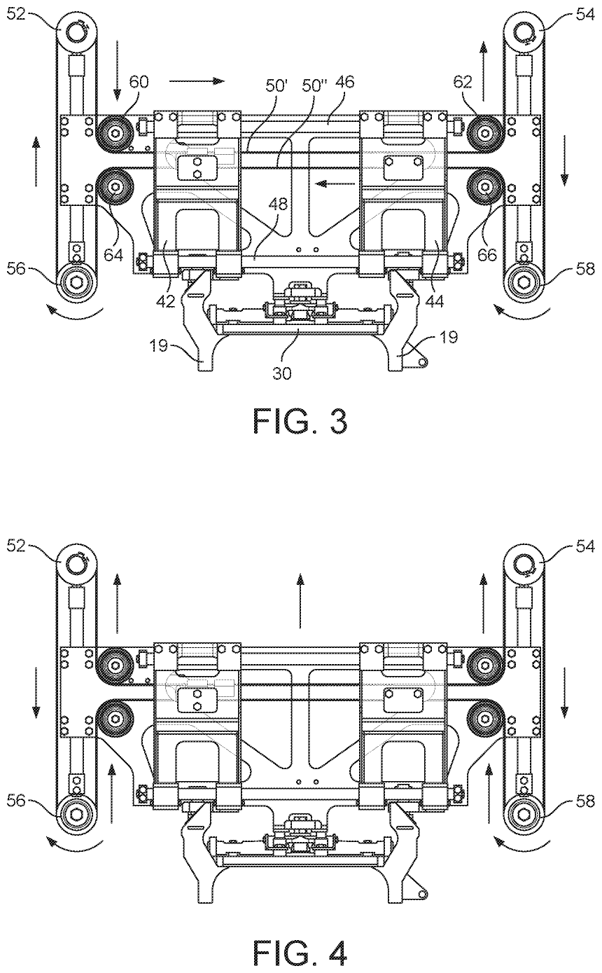

Each side guide 19 is rigidly coupled to a respective guide support 42, 44. Each guide support is coupled to the main body 36 in such a way that is it is able to move linearly relative to the main body, along a direction orthogonal to the linear motion of the main body relative to the supporting framework. The guide supports may be slidably coupled to a pair of elongate parallel guide members 46, 48 (visible in the example of FIGS. 3 and 4) which are rigidly mounted onto the main body.

Preferably, each side guide 19 is profiled on its surface facing the opposite side guide such that it curves inwardly in the vertical direction. This may enable the side guides to conform more closely to the shape of a food product and thereby more closely constrain its cross-sectional shape as it passes beneath the assembly.

The positioning mechanism is shown in two different configurations in FIG. 2. The first is shown using solid lines and the second using dashed lines. In the first configuration, the positioning mechanism is arranged such that the top guide 30 is located at one end of its range of motion relative to the supporting framework where it is closest to the supporting framework. In the second configuration, the positioning mechanism is arranged such that the top guide is located at the opposite end of its range of motion relative to the supporting framework, where it is furthest from the supporting framework (this position is denoted 30′ in FIG. 2).

Similarly, in the first configuration, the positioning mechanism is arranged such that the side guides 19 are located with a maximum spacing between them. In the second configuration, the positioning mechanism is arranged such that the side guides are located with a minimum spacing (these locations are denoted 19′ in FIG. 2).

The positioning mechanism is operable to independently (i) move the top and side guides relative to the supporting framework and (ii) move the side guides relative to the top guide.

The mechanism includes a single, continuous drive belt 50. The drive belt extends around four pulleys 52, 54, 56 and 58 and four guide wheels 60, 62, 64 and 66. The four pulleys and four guide wheels have axes of rotation which are orientated parallel to each other. The pulleys 52 and 56 are located adjacent to the upper and lower ends, respectively, of the guide member 38, whilst the pulleys 54 and 58 are located adjacent to the upper and lower ends, respectively of the guide member 40. Each of the pulleys is rotatably coupled to the supporting framework at a respective fixed location. The four guide wheels are located inwardly of the pulleys, in both vertical and horizontal directions.

The pulleys and guide wheels are located such that the drive belt is able to run in a vertical direction to and from each pulley and in a horizontal direction between guide wheels 60 and 62 and between guide wheels 64 and 66. This may be referred to as an “H bot” configuration as the path of the belt forms an H-shape.

The guide support 42 is rigidly coupled to an upper strand 50′ of the drive belt, whilst guide support 44 is rigidly coupled to a lower strand 50″ of the drive belt.

FIGS. 3 and 4 are marked with arrows indicating directions of motion of the drive belt in two different modes of operation of the positioning mechanism. In the mode shown in FIG. 3, all four of the pulleys are rotating in the same direction about their axes of rotation. This causes the upper and lower strands 50′, 50″ of the drive belt to move in opposite directions. When the pulleys are rotated in a clockwise direction (when viewed in FIG. 3) this causes the guide supports 42, 44 (and therefore the side guides 19) to move towards each other. Conversely, when the pulleys are rotated in an anticlockwise direction, this causes the guide supports (and therefore the side guides 19) to move further apart.

In the mode shown in FIG. 4, pulleys 52 and 56 are rotating in an anticlockwise direction, whilst pulleys 54 and 58 are rotated clockwise. This causes the belt to lift the main body 36 (and therefore the top guide 30 and side guides 19) vertically along guide members 38, 40. The upper and lower strands 50′ and 50″ of the drive belt do not move relative to each other in this mode and so the spacing of the side guides 19 is unchanged. Alternatively, when pulleys 52 and 56 are rotated in a clockwise direction whilst pulleys 54 and 58 are rotated anticlockwise, the belt lowers the main body 36 (and therefore the top guide 30 and side guides 19) relative to the supporting framework along the guide members 38, 40.

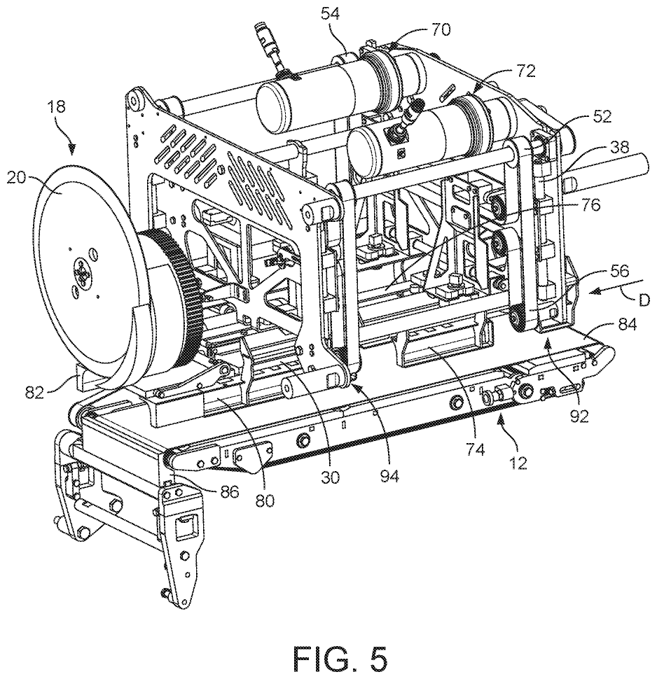

First and second drive motors 70, 72 (shown in FIGS. 2 and 5) are mounted on the supporting framework 34. The first drive motor 70 is coupled to pulley 52 so as to be able to drive rotation of this pulley, whilst the second drive motor 72 is similarly coupled to pulley 54. The drive motors may be servomotors for example.

The drive motors 70, 72 are communicatively coupled to a controller 5 of the food portioning machine.

If only one of pulleys 52 and 54 is rotated by the corresponding motor, the main body is caused to move relative to the supporting framework at the same time as the guide supports are caused to move relative to the main body. By driving the pulleys 52 and 54 simultaneously at different speeds, the speed of the motion of the main body relative to the supporting framework may be controlled independently of the speed of the simultaneous motion of the guide supports relative to the main body.

FIG. 5 shows an example of a product control assembly 17 as described herein in combination with a cutter 18 and a conveyor 12 of a food portioning machine. During operation of the machine, food products travel along a flow path direction D onto the conveyor 12. The flow path extends below the assembly 17 and the cutting mechanism. As food products emerge from the forming module, pass beneath the product control assembly and past the cutting mechanism, their position and orientation on the conveyor is controlled by the assembly.

The top guide 30 is elongated along a longitudinal axis which is parallel to the flow path direction D. In this example, the positioning mechanism carries two pairs of side guides, namely a first pair 74, 76 and a second pair 80, 82 which is located downstream of the first pair. In order to carry opposite ends of the top guide and the second pair of side guides, the assembly shown in FIG. 5 includes a second, downstream H bot mechanism 94 which is also carried by the supporting framework and driven by the drive motors 70, 72 to carry out the same motions as the upstream H bot mechanism 92.

The conveyor 12 includes a conveyor belt 84, the upper surface of which defines a support plane of the food portioning machine. A cutting edge 86 is provided adjacent to the downstream end of the conveyor belt.

The cutting mechanism includes a cutter in the form of a circular blade which is mounted for orbital motion so that it interacts with the cutting edge 86 to cut portions from the leading end of a food product which extends beyond the cutting edge.

The controller 5 is able to generate control signals for the first and second drive motors 70, 72. The control signals may instruct the drive motors to move the top and side guides to specific positions. The control signals may also dictate the maximum control force to be exerted on a food product by the side guides and/or the top guide of the assembly. The control signals may be generated with reference to data related to the external profile (and potentially other physical properties) of an individual food product (or a group of products) that is to be controlled using the control assembly.

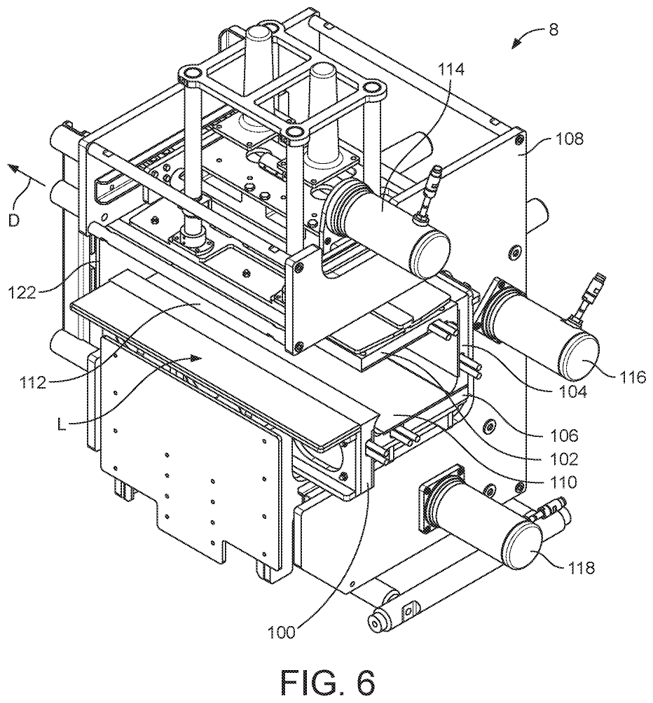

The forming module 8 of the food processing machine shown in FIG. 1 will now be described with reference to FIGS. 6 to 12. The module comprises four dies, namely a front side die 100, a top die 102, a rear side die 104 and a lower die 106. The dies are carried by a supporting framework 108 and arranged to receive a food product in a food product receiving chamber 112.

Each die is mounted on the supporting framework 108 in such a way as to be movable transversely with respect to the flow path followed by a food product leaving the forming module, in a direction D. A first drive motor 114 is provided for moving the upper die 102 vertically, towards and away from the lower die 106. A second drive 116 is operable to move the rear side die 104 and the top die 102 horizontally towards and away from the front side die 100. A third drive 118 is arranged to move the front side die 100 and the lower die 106 horizontally. A force sensor may be provided in combination with each drive motor for sensing the magnitude of a force opposing movement of an associated die by the respective drive motor. Signals generated by the force sensors are fed back to the controller 5 and used to govern the amount of pressure exerted on a food product in the forming module by the dies.

The forming module is arranged to receive a food product along a transverse direction, in loading direction “L”, into the receiving chamber 112. As shown in FIG. 6, a transverse side of the chamber is opened to receive a food product by lowering the front side die 100.

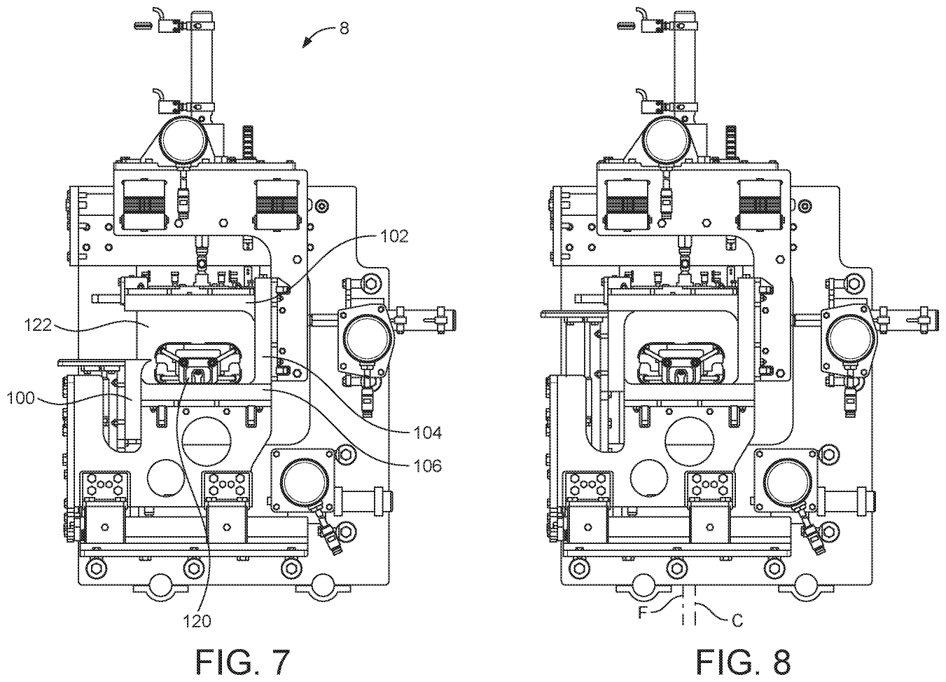

The operation of the forming module will now be described reference to FIGS. 7 to 10. The configuration of the dies shown in FIG. 7 corresponds to that depicted in FIG. 6. The front side die 100 has been lowered.

A size-adaptive end pusher 120 (described in more detail below) is located adjacent to an upstream end 110 of the chamber 112. An end gate 122 closes the downstream end of the chamber.

After a food product has been inserted into the chamber, the open transverse side of the chamber is closed by raising the front side die 100 until it comes into contact with the upper die 102, forming the configuration shown in FIG. 8.

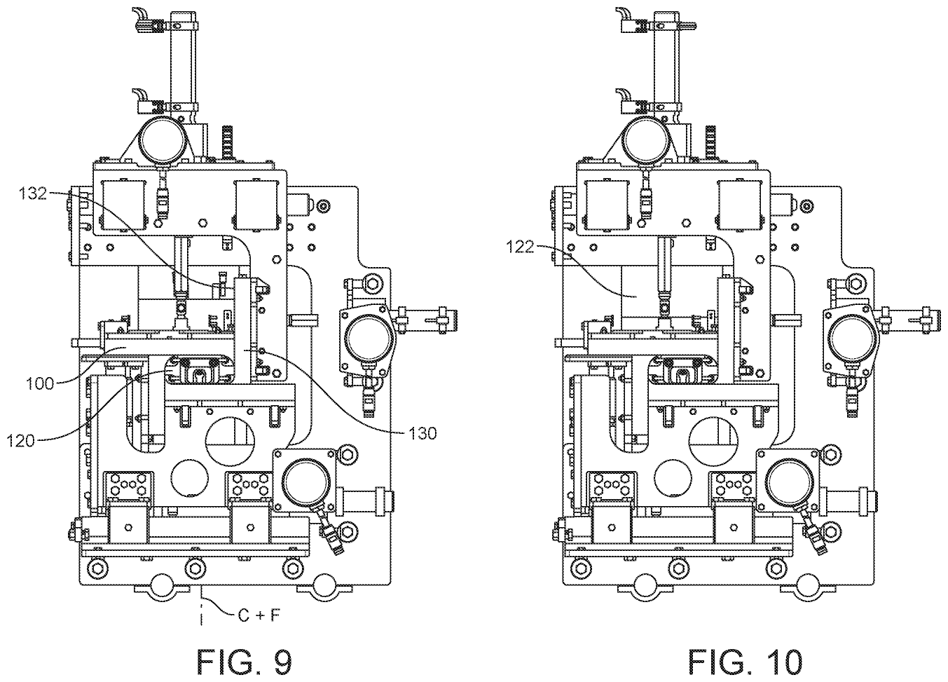

The transverse cross-section of the chamber is then reduced by moving a longitudinally extending side of each die over a shaping surface of adjacent die. For example, it can be seen in FIG. 9 that a longitudinally extending side 130 of upper die 100 has moved over the shaping surface 132 of the rear side die 104. In this way, the dies move between a configuration which defines a large transverse product profile as shown in FIG. 8, to a configuration defining a smaller transverse product profile as shown in FIG. 9.

Forces exerted on the size adaptive end pusher 120 by the dies of the forming module cause the end pusher to contract to a more compact configuration as shown in FIG. 9, which corresponds to the smaller transverse product profile. The end pusher is urged towards the end gate 122 to exert compressive forces on a food product located in the module in a longitudinal direction, parallel to direction D.

Then, as shown in FIG. 10, the end gate 122 is raised, allowing the food product to be ejected from the forming module by advancing the end pusher through the chamber, along direction D.

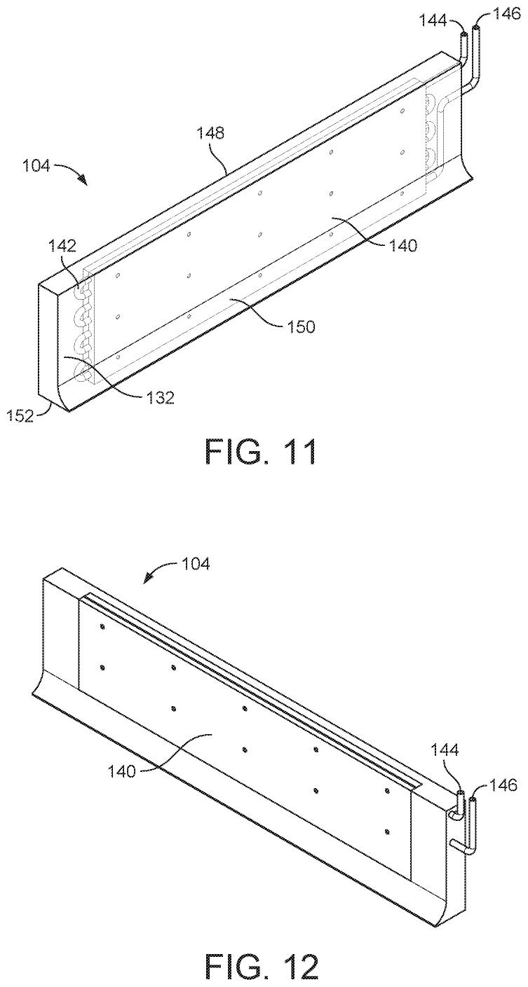

The rear side die is shown separately in FIGS. 11 and 12 to illustrate the construction of each die. The die includes a stainless steel food product contact plate 140. Within the die, a flow path for a fluid coolant is defined by fluid conduit 142 which extends back and forth behind the plate. For the purposes of illustration, the die is shown as partially transparent in FIG. 11 so that the conduit 142 is visible. Coolant is fed to and from the fluid conduit 142 via an inlet 144 and an outlet 146. The body of the die on the opposite side 148 to the contact plate 140 is formed from an insulating material such as a polymer.

The body of the die together with the contact plate 140 forms a shaping surface 132 of the die for contacting a food product. A marginal, longitudinal portion 150 of this shaping surface curves outwardly away from the plane of the contact plate so as to form a corresponding curved profile on a food product. The die also defines a longitudinally extending side 152 which meets the curved portion 150. In the assembled forming module, the side 150 engages with and moves over the shaping surface of the lower die 106.

The lower die 106 is able to move laterally relative to the supporting framework 108 of the forming module. This motion is driven by the drive 118. Accordingly, the lower die is able to move to adjust the lateral position of the food product in the food processing machine so that the food product, when compressed by the forming module, is in alignment with a centre line of the flow path through the machine. The food product can thereby be aligned with a downstream module of the machine. A vertical plane “C” containing the centre line of the flow path is marked on FIGS. 8 and 9, and a vertical plane “F” passing through the centre of the chamber 112 is marked on FIG. 8. It can be seen that, as the forming module moves from the large transverse product profile configuration shown in FIG. 8 to the smaller transverse product profile configuration shown in FIG. 9, the vertical plane F is brought into alignment with the plane C.

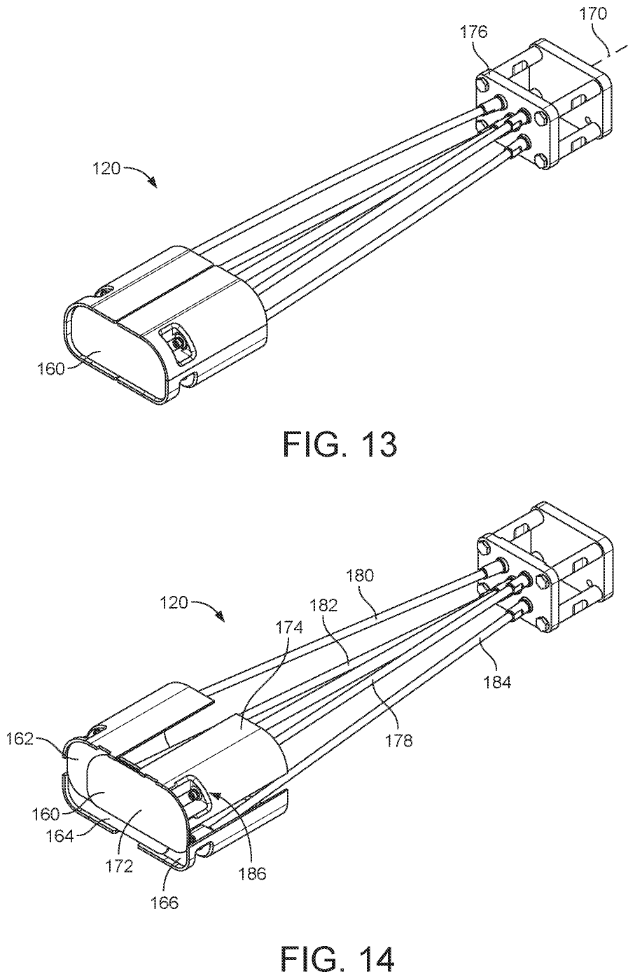

The size-adaptive end pusher 120 of the forming module is shown in FIGS. 13 and 14. It includes four pusher elements 160, 162, 164 and 166. Each pusher element defines a planar front face which extends transversely with respect to a longitudinal axis 170 of the pusher. Each pusher element also defines a longitudinally extending outer side face which is perpendicular to its front face. For example, pusher element 160 has a front face 172 and an outer side face 174.

Each pusher element 160, 162, 164 and 166 is coupled to a pusher mount 176 by a respective resilient support 178, 180, 182 and 184. The resilient supports are rigid in the longitudinal direction and therefore able to transmit longitudinal forces exerted on the support by the pusher mount onto the pusher elements. The resilient supports are in the form of narrow rods having one end coupled to the pusher mount and the other end coupled to the respective pusher element. Each of the other ends is coupled to a respective pusher element by an articulated joint (numbered 186 in the case of pusher element 160) which allows the pusher element to pivot relative to its resilient support.

The end pusher is shown in a contracted configuration in FIG. 13 and an expanded configuration in FIG. 14. Each resilient support acts to urge the respective pusher element outwardly, generally away from the longitudinal axis 170 of the end pusher. As can be seen in FIG. 14, the front faces of the pusher elements overlap when viewed in the longitudinal direction. The front faces are defined by a relatively thin plate of rigid material and are located closely together so that, in the expanded configuration, the front faces combine to form an expanded, substantially planar surface for engagement with an end of the food product.

When the end pusher is located within the chamber of the forming module, the side faces of the pusher elements engage with the shaping surfaces of the forming module and are biased against them by the resilient supports. The side faces are thereby aligned to be parallel with the longitudinal axis 170. This in turn results in the front faces being arranged to be substantially perpendicular to this axis, so as to form a planar surface for engagement with a food product which is perpendicular to the longitudinal axis. The end pusher therefore tends to form a corresponding flat face on the end of a food product as it is compressed by the forming module, so that the end portion of the food product may then be used to form a usable portion, rather than be discarded.

As the forming module contracts, the dies act radially inwardly on the pusher elements, causing them to move towards a contracted configuration. As the end pusher is able to conform with the reducing transverse cross-section of the forming module, it minimises any risk of “escape” of the food product between the dies and the outer circumference of the end pusher which would cause undesirable deformation of the end portion of the food product.

It will be appreciated that references herein to perpendicular or parallel relative orientations and the like are to be interpreted as defining perpendicular or parallel relationships between components within practical tolerances.

The following enumerated paragraphs represent illustrative, non-exclusive ways of describing examples according to the present disclosure.
A. A food processing machine comprising:
a cutter configured to cut portions from a food product;
a forming module for changing the shape of a food product; a transport system arranged to carry a food product along a product flow path from the forming module to the cutter; and
a profile sensor configured to sense a profile of part of a food product as a food product is carried from the forming module to the cutter through a sensing region of the machine by the transport system,
wherein a food product is continuously constrained against movement laterally with respect to the product flow path by the transport system as the food product travels from the forming module to the cutter via the sensing region.
A1. A machine of paragraph A, wherein the forming module is operable to cool the surface of a food product.
A2. A machine of paragraph A1, wherein the forming module includes a die for engaging a food product in order to change the shape of the food product, and the forming module is operable to extract heat energy from the die.
A3. A machine of paragraph A, wherein the product flow path from the forming module to the cutter is inclined relative to horizontal.
A4. A machine of paragraph A, wherein the forming module includes a support structure, and a base for supporting a food product, wherein the base is carried by the support structure, and the base is moveable relative to the support structure to adjust laterally the location of a food product relative to the product flow path.
A5. A machine of paragraph A wherein the forming module comprises at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations.
B. A forming module for changing the shape of a food product located in the module, wherein:
the module comprises at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations.
B1. A module of paragraph B, wherein the module includes four dies.
B2. A module of paragraph B, wherein one of the dies is a front side die which defines a side portion of the transverse product profile, and the front side die is retractable so as to enable insertion of a food product into the module in a transverse direction.
B3. A module of paragraph B including a first drive for moving an upper die towards and away from a lower die in a transverse direction, and a second drive for moving a rear side die and a top die towards and away from a or the front side die in a transverse direction.
B4. A module of paragraph B3 including an upper die force sensor for generating a signal indicative of the magnitude of a force opposing movement of the upper die towards the lower die in a transverse direction.
B5. A module of paragraph B including a rear side die force sensor for generating a signal indicative of the magnitude of a force opposing movement of the rear side die towards the front side die in a transverse direction.
B6. A module of paragraph B including a third drive for moving the front side die and lower die towards and away from the rear side die in a transverse direction.
C. A size-adaptive end pusher for use in a food product forming module, the end pusher being driven in use to exert a pushing force on a food product in a direction along a longitudinal axis of the end pusher and comprising:
two pusher elements, each defining a transversely extending front face for engaging with a food product,
wherein the pusher elements are movable between a transversely expanded configuration and a transversely contracted configuration, with the front faces overlapping when viewed in the longitudinal direction to a greater extent in the expanded configuration relative to the contracted configuration, and the pusher elements are resiliently biased away from the transversely contracted configuration towards the transversely expanded configuration.
C1. An end pusher of paragraph C including at least four pusher elements.
C2. An end pusher of paragraph C, including:
a pusher mount, and
a resilient support between the pusher mount and a respective pusher element,
wherein each resilient support urges the respective pusher element away from its position in the contracted configuration towards its position in the expanded configuration.
C3. An end pusher of paragraph C2, wherein each resilient support comprises a resilient rod having one end coupled to the pusher mount and the other end coupled to the respective pusher element.
C4. An end pusher of paragraph C2, wherein each other end of each resilient support is coupled to the respective pusher element by a coupling which allows the pusher element to pivot about the other end.
C5. An end pusher of paragraph C, wherein each pusher element defines a longitudinally extending outer side face which is perpendicular to its front face, for engaging with an inner wall of a food product forming module.
D. A food processing machine including a forming module for changing the shape of a food product located in the module, wherein:
the module comprises at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations.
E. A method of processing a food product with a food processing machine, the method comprising the steps of:
changing the shape of the food product in a forming module of the machine;
transporting the food product along a product flow path from the forming module to a cutter of the machine using a transport system of the machine; and
sensing a profile of part of the food product as it is transported from the forming module to the cutter,
wherein food product is continuously constrained against movement laterally with respect to the product flow path by the transport system as the food product travels from the forming module to the cutter via the sensing region.
E1. A method of paragraph E, wherein the forming module includes a base for supporting a food product, and the method includes a step of adjusting laterally the location of the base within the machine relative to the product flow path through the machine to laterally adjust the location of a food product carried by the base relative to the product flow path.
F. A method for changing the shape of a food product located in a food product forming module, wherein:
the module comprises a support structure and at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations,
the method comprising the steps of:
inserting a food product into the forming module, and
moving the dies from the large transverse product profile configuration to the small transverse product profile configuration to change the shape of the food product.
F1. A method of paragraph F including a step of: extracting heat energy from the dies to cool the surface of the food product.
F2. A method of paragraph F, wherein one of the dies is a lower die for supporting a food product, wherein the method includes moving the lower die relative to the support structure in a transverse direction to adjust laterally the location of a food product relative to a product flow path.

1. A food processing machine comprising:
a cutter configured to cut portions from a food product;
a forming module for changing the shape of a food product;
a transport system arranged to carry a food product along a product flow path from the forming module to the cutter; and
a profile sensor configured to sense a profile of part of a food product as a food product is carried from the forming module to the cutter through a sensing region of the machine by the transport system,
wherein a food product is continuously constrained against movement laterally with respect to the product flow path by the transport system as the food product travels from the forming module to the cutter via the sensing region.

2. A machine of claim 1, wherein the forming module is operable to cool the surface of a food product.

3. A machine of claim 2, wherein the forming module includes a die for engaging a food product in order to change the shape of the food product, and the forming module is operable to extract heat energy from the die.

4. A machine of claim 1, wherein the product flow path from the forming module to the cutter is inclined relative to horizontal.

5. A machine of claim 1, wherein the forming module includes a support structure, and a base for supporting a food product, wherein the base is carried by the support structure, and the base is moveable relative to the support structure in a lateral direction to adjust laterally the location of a food product relative to the product flow path.

6. A forming module for changing the shape of a food product located in the module, wherein:
the module comprises at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations.

7. A module of claim 7, wherein the module includes four dies.

8. A module of claim 6, wherein one of the dies is a front side die which defines a side portion of the transverse product profile, and the front side die is retractable so as to enable insertion of a food product into the module in a transverse direction.

9. A module of claim 6 including a first drive for moving an upper die towards and away from a lower die in a transverse direction, and a second drive for moving a rear side die and a top die towards and away from a or the front side die in a transverse direction.

10. A module of claim 9 including an upper die force sensor for generating a signal indicative of the magnitude of a force opposing movement of the upper die towards the lower die in a transverse direction.

11. A module of claim 9 including a rear side die force sensor for generating a signal indicative of the magnitude of a force opposing movement of the rear side die towards the front side die in a transverse direction.

12. A module of claim 9 including a third drive for moving the front side die and lower die towards and away from the rear side die in a transverse direction.

13. A size-adaptive end pusher for use in a food product forming module, the end pusher being driven in use to exert a pushing force on a food product in a direction along a longitudinal axis of the end pusher and comprising:
two pusher elements, each defining a transversely extending front face for engaging with a food product,
wherein the pusher elements are movable between a transversely expanded configuration and a transversely contracted configuration, with the front faces overlapping when viewed in the longitudinal direction to a greater extent in the expanded configuration relative to the contracted configuration, and the pusher elements are resiliently biased away from the transversely contracted configuration towards the transversely expanded configuration.

14. An end pusher of claim 13 including at least four pusher elements.

15. An end pusher of claim 13, including:
a pusher mount, and
a resilient support between the pusher mount and a respective pusher element,
wherein each resilient support urges the respective pusher element away from its position in the contracted configuration towards its position in the expanded configuration.

16. An end pusher of claim 15, wherein each resilient support comprises a resilient rod having one end coupled to the pusher mount and the other end coupled to the respective pusher element.

17. An end pusher of claim 15, wherein each other end of each resilient support is coupled to the respective pusher element by a coupling which allows the pusher element to pivot about the other end.

18. An end pusher of claim 13, wherein each pusher element defines a longitudinally extending outer side face which is perpendicular to its front face, for engaging with an inner wall of a food product forming module.

19. A forming module of claim 6,
further comprising
a size-adaptive end pusher for use in a food product forming module, the end pusher being driven in use to exert a pushing force on a food product in a direction along a longitudinal axis of the end pusher and comprising:
two pusher elements, each defining a transversely extending front face for engaging with a food product,
wherein the pusher elements are movable between a transversely expanded configuration and a transversely contracted configuration, with the front faces overlapping when viewed in the longitudinal direction to a greater extent in the expanded configuration relative to the contracted configuration, and the pusher elements are resiliently biased away from the transversely contracted configuration towards the transversely expanded configuration.

20. A food processing machine including a forming module of claim 6.

21. A food processing machine of claim 1,
further comprising
a forming module for changing the shape of a food product located in the module, wherein:
the module comprises at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations.

22. A method of processing a food product with a food processing machine, the method comprising the steps of:
changing the shape of the food product in a forming module of the machine;
transporting the food product along a product flow path from the forming module to a cutter of the machine using a transport system of the machine; and
sensing a profile of part of the food product as it is transported from the forming module to the cutter,
wherein food product is continuously constrained against movement laterally with respect to the product flow path by the transport system as the food product travels from the forming module to the cutter via the sensing region.

23. A method of claim 22, wherein the forming module includes a base for supporting a food product, and the method includes a step of adjusting laterally the location of the base within the machine relative to the product flow path through the machine to laterally adjust the location of a food product carried by the base relative to the product flow path.

24. A method for changing the shape of a food product located in a food product forming module, wherein:
the module comprises a support structure and at least three dies, with each die defining an inwardly facing shaping surface, the shaping surfaces of the dies defining a transverse product profile,
the dies are moveable between a large transverse product profile configuration and a small transverse product profile configuration, and
each die has a longitudinally extending side which moves over the shaping surface of an adjacent die when the dies move between the larger and smaller transverse product profile configurations,
the method comprising the steps of:
inserting a food product into the forming module, and
moving the dies from the large transverse product profile configuration to the small transverse product profile configuration to change the shape of the food product.

25. A method of claim 24 including a step of:
extracting heat energy from the dies to cool the surface of the food product.

26. A method of claim 24, wherein one of the dies is a lower die for supporting a food product, wherein the method includes moving the lower die relative to the support structure in a transverse direction to adjust laterally the location of a food product relative to a product flow path.
